(19) United States
(12) Patent Application Publication
(10) Pub. No.: US 2025/0211298 A1
(43) Pub. Date: Jun. 26, 2025

(54) HIGH RANK DOWNLINK TRANSMISSION BASED ON NR RELEASE 15 TYPE II CSI REPORT

(71) Applicant: Telefonaktiebolaget LM Ericsson (publ), Stockholm (SE)

(72) Inventors: Jianguo LONG, Ottawa, Ontario (CA); Yongquan QIANG, Ottawa, Ontario (CA); Shaohua LI, Kanata, Ontario (CA)

(73) Assignee: Telefonaktiebolaget LM Ericsson (publ), Stockholm (SE)

(21) Appl. No.: 18/851,073

(22) PCT Filed: Apr. 26, 2022
(86) PCT No.: PCT/IB2022/053859

§ 371 Date: Sep. 26, 2024

(51) Int. Cl. H04B 7/0456

(52) U.S. Cl. CPC H04B 7/0486

(57) ABSTRACT

Systems and methods for enabling high rank transmissions for downlink Physical Downlink Shared Channel (PDSCH) transmissions based on a Channel State Information (CSI) report are provided. In some embodiments, a method performed by a Radio Access Network (RAN) node in a RAN of a cellular communications system comprises receiving a CSI report from a wireless communication device. The CSI report comprises a rank indicator that indicates a rank value of 2. The method further comprises selecting, based on the CSI report, a rank γ(>2) for downlink transmission to the wireless communication device, generating a rank γ precoder based on the CSI report, precoding a downlink signal to be transmitted to the wireless communication device based on the rank γ precoder to provide a precoded downlink signal, and transmitting the precoded downlink signal to the wireless communication device.

### TECHNICAL FIELD

The present disclosure is directed to methods and systems used to enable high rank transmissions for New Radio (NR) downlink Physical downlink Shared Channel (PDSCH) transmissions based on Third Generation Partnership Project (3GPP) release 15 type II Channel State Information (CSI) report.

### BACKGROUND

Third Generation Partnership Project (3GPP) introduced Type II codebook with the main motivation to enable good Multi-user Multiple Input Multiple Output (MU-MIMO) performance in New Radio (NR) Frequency Division Duplex (FDD) systems. MU-MIMO is a technique widely used in massive MIMO systems. With MU-MIMO, two or more users in the same cell are co-scheduled on the same time-frequency resource. That is, two or more independent data streams are transmitted to different User Equipments (UEs) at the same time, and the spatial domain is used to separate the respective streams.

By transmitting several streams simultaneously, the capacity of the system can be increased. In order to perform appropriate null forming between co-scheduled users, accurate Channel State Information (CSI) is required.

For Time Division Duplex (TDD) systems, downlink channel estimates can be obtained from uplink signals, for example, with the help of Sounding Reference Signals (SRS), thanks to channel reciprocity.

This approach doesn't work for FDD as the short-term reciprocity between Uplink (UL) and Downlink (DL) carriers does not hold. To allow a New Radio Base Station (gNB) in FDD systems to get necessary channel information for MU-MIMO, the solution adopted by 3GPP is to let UE to feedback channel information via a type II CSI report.

The precoders in type II CSI report is, roughly speaking, complex conjugated and quantized downlink sub-band channel matrix. There are two ways for a gNB to use the type II CSI report: first, the gNB can use precoders reported by the type II CSI report for SU-MIMO transmission; and second, the gNB can derive downlink channel estimates from the type II CSI report to calculate MU-MIMO beamforming weights for MU-MIMO transmissions.

However, there is a problem with 3GPP Release 15 type II codebook when it is used for Single-user Multiple Input Multiple Output (SU-MIMO) transmissions: it supports only up to 2 layer transmission, while NR downlink SU-MIMO transmission is typically up to 4 layers.

### SUMMARY

Embodiments for enabling high rank transmissions for New Radio (NR) downlink Physical downlink Shared Channel (PDSCH) transmissions based on Third Generation Partnership Project (3GPP) release 15 type II Channel State Information (CSI) report are disclosed in the present disclosure. In one embodiment, a method performed by a Radio Access Network (RAN) node in a RAN of a cellular communications system comprises receiving a CSI report from a wireless communication device. The CSI report comprises a rank indicator that indicates a rank value of 2. The method further comprises selecting, based on the CSI report, a rank γ(>2) for downlink transmission to the wireless communication device, generating a rank γ precoder based on the CSI report, precoding a downlink signal to be transmitted to the wireless communication device based on the rank γ precoder to provide a precoded downlink signal, and transmitting the precoded downlink signal to the wireless communication device. In this way, the downlink rank 3 and rank 4 single user (SU) transmissions can be enabled in NR Frequency Division Duplex (FDD) systems configured with a single release 15 type II CSI report without need to configure another type I CSI report.

In one embodiment, the step of generating the rank γ precoder based on the CSI report comprises generating the rank γ precoder based on a rank 2 sub-band precoder indicated by the CSI report.

In one embodiment, the rank 2 sub-band precoder indicated by the CSI report is defined as:

$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$

where Wₚ_{ₖ}^{l} is a precoder for layer l and polarization k, and the rank γ precoder is generated based on Wₚ_{₁}¹, Wₚ_{₂}¹, Wₚ_{₁}², and Wₚ_{₂}² such that each column of a corresponding matrix is orthogonal or quasi-orthogonal to each other column of the corresponding matrix.

In one embodiment, the rank γ is rank 3, the rank 2 sub-band precoder indicated by the CSI report is defined as:

$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$

where Wₚ_{ₖ}^{l} is a precoder for layer l and polarization k, and a rank 3 sub-band precoder is generated as or a column-permutated version of:

$${W}^{( 3 )} = \frac{1}{\sqrt{3}} [ \begin{matrix}{W}_{{p}_{1}}^{1} & {W}_{{p}_{1}}^{1} & {W}_{{p}_{1}}^{2} \\ {W}_{{p}_{2}}^{1} & - {W}_{{p}_{2}}^{1} & {W}_{{p}_{2}}^{2}\end{matrix} ]$$

In one embodiment, the rank γ is rank 4, the rank 2 sub-band precoder indicated by the CSI report is defined as:

$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$

where Wₚ_{ₖ}^{l} is a precoder for layer l and polarization k, and a rank 4 sub-band precoder is generated as or a column-permutated version of:

$${W}^{( 4 )} = \frac{1}{2} [ \begin{matrix}{W}_{{p}_{1}}^{1} & {W}_{{p}_{1}}^{1} & {W}_{{p}_{1}}^{2} & {W}_{{p}_{1}}^{2} \\ {W}_{{p}_{2}}^{1} & - {W}_{{p}_{2}}^{1} & {W}_{{p}_{2}}^{2} & - {W}_{{p}_{2}}^{2}\end{matrix} ]$$

In one embodiment, the step of generating the rank γ precoder based on the CSI report comprises generating the rank γ sub-band precoder based on at least two of two or more base beams indicated by the CSI report for a rank 2 sub-band precoder.

In one embodiment, the rank γ is rank 3, and a rank 3 sub-band precoder is generated as or a column-permutated version of:

$${W}^{( 3 )} = \frac{1}{\sqrt{3}} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}}\end{matrix} ]$$

where vₘ_{₁}_{⁽⁰⁾}_{,m}_{₂}_{⁽⁰⁾} and vₘ_{₁}_{⁽¹⁾}_{,m}_{₂}_{⁽¹⁾} are two of the two or more base beams indicated by the CSI report for the rank 2 sub-band precoder, and φ_{l,i} and φ_{l,i+L}, i=0, 1, are sub-band phase coefficients.

In one embodiment, the rank 3 wideband precoder, W⁽³⁾, is simplified as

$${W}^{( 3 )} = \frac{1}{\sqrt{3}} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}}\end{matrix} ]$$

wherein φ_{l,i} and φ_{l,i+L} are set to 1 and vₘ_{₁}_{⁽ⁱ⁾}_{,m}_{₂}_{⁽ⁱ⁾}, i=0, 1.

In one embodiment, the rank γ is rank 4, and a rank 4 sub-band precoder is generated as or a column-permutated version of:

$${W}^{( 4 )} = \frac{1}{2} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}} & - {v}_{{m}_{1}^{( 1 )} , {m}_{2}^{( 1 )} {φ}_{l , L + 1}}\end{matrix} ]$$

where vₘ_{₁}_{⁽⁰⁾}_{,m}_{₂}_{⁽⁰⁾} and vₘ_{₁}_{⁽¹⁾}_{,m}_{₂}_{⁽¹⁾} are two of the two or more base beams indicated by the CSI report for the rank 2 sub-band precoder, and φ_{l,i} and φ_{l,i+L}, i=0, 1, are sub-band phase coefficients.

In one embodiment, the rank 4 wideband precoder, W⁽⁴⁾, is simplified as

$${W}^{( 4 )} = \frac{1}{2} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}} & - {v}_{{m}_{1}^{( 1 )} , {m}_{2}^{( 1 )}}\end{matrix} ]$$

wherein φ_{l,i} and φ_{l,i+L} are set to 1 and vₘ_{₁}_{⁽ⁱ⁾}_{,m}_{₂}_{⁽ⁱ⁾}, i=0, 1.

In one embodiment, the CSI report comprises one or more Channel Quality Indictor, CQI, values for rank 2.

In one embodiment, the step of selecting the rank γ for downlink transmission to the wireless communication device comprises selecting the rank γ based on the one or more CQI values for rank 2 comprised in the CSI report.

In one embodiment, the step of selecting the rank γ for downlink transmission to the wireless communication device comprises selecting the rank γ based on the one or more CQI values for rank 2 comprised in the CSI report and a power control offset value configured for the wireless communication device.

In one embodiment, the one or more CQI values comprise two or more CQI values for rank 2 for two or more sub-bands, and selecting the rank γ comprises: (i) computing a wideband Signal-to-Noise Ratio (SNR) value for rank 2 based on the two or more CQI values for rank 2 for the two or more sub-bands and the power control offset value configured for the wireless communication device, (ii) computing a wideband SNR value for each rank γ from among two or more additional ranks based on the two or more CQI values for rank 2 for the two or more sub-bands and the power control offset value configured for the wireless communication device. γ is greater than 2 and is equal to or less than N that is a maximum rank, (iii) selecting a certain rank among ranks 2, 3, . . . , and N, based on the wideband SNR values computed for rank 2 and ranks γ among the two or more additional ranks.

In one embodiment, the step of computing the wideband SNR value for rank 2 based on the two or more CQI values for rank 2 for the two or more sub-bands and the power control offset value configured for the wireless communication device comprises computing non-shifted SNR values for rank 2 ( [symbol] _{sb}⁽²⁾) by using:

$${sb}_{( 2 )}^{} = {SNR}_{sb}^{( 2 )} - powerControlOffset$$

wherein SNR_{sb}⁽²⁾ is SNR values for rank 2 CSI report; powerControlOffset is a power control offset that is an assumed ratio of Physical Downlink Shared Channel (PDSCH) Energy Per Resource Element (EPRE) to Non-Zero Power (NZP) Channel State Information Reference Signal (CSI-RS) EPRE.

In one embodiment, the step of computing the wideband SNR value for each rank γ based on the two or more CQI values for rank 2 for the two or more sub-bands and the power control offset value configured for the wireless communication device comprises computing non-shifted SNR values for rank γ [symbol] _{sb}^{(γ)}) by using:

$${sb}_{( γ )}^{} = 10 {log}_{10} ( \frac{2}{γ} ) + {SNR}_{sb}^{( 2 )} - powerControlOffset + {OLA}^{( γ )}$$

wherein SNR_{sb}⁽²⁾ is SNR values for rank 2 CSI report; powerControlOffset is a power control offset that is an assumed ratio of PDSCH EPRE, to NZP CSI-RS EPRE; OLA^{(γ)} is an outer-loop adjustment for the rank γ.

In one embodiment, the step of computing the wideband SNR value for each rank γ based on the two or more CQI values for rank 2 for the two or more sub-bands and the power control offset value configured for the wireless communication device further comprises computing the wideband SNR value for each rank γ by using:

$${wb}_{( γ )}^{} = \frac{1}{{N}_{sb}} {\sum }_{sb = 0}^{{N}_{sb} - 1} {sb}_{( γ )}^{}$$

wherein [symbol] _{sb}^{(γ)} is non-shifted SNR values for rank γ and N_{sb} is a number of sub-bands.

In one embodiment, the step of selecting the certain rank among ranks 2, 3, . . . , and N, based on the wideband SNR values computed for rank 2 and ranks γ comprises selecting the certain rank by using:

$${γ}^{*} = {arg max}_{2 \leq γ \leq N} ( {wb}_{( γ )}^{} )$$

Corresponding embodiments of the RAN are also disclosed.

In one embodiment, a RAN node in a RAN of a cellular communications system is adapted to receive, a CSI report from a wireless communication device. The CSI report comprises a rank indicator that indicates a rank value of 2. The RAN node is also adapted to select, based on the CSI report, a rank γ (>2) for downlink transmission to the wireless communication device. The RAN node is also adapted to generate a rank γ precoder based on the CSI report; precode a downlink signal to be transmitted to the wireless communication device based on the rank γ precoder to provide a precoded downlink signal; and transmit the precoded downlink signal to the wireless communication device.

In one embodiment, a RAN node in a RAN of a cellular communications system comprises processing circuitry configured to cause the RAN node to receive, a CSI report from a wireless communication device. The CSI report comprises a rank indicator that indicates a rank value of 2. The processing circuitry is further configured to cause the RAN node to generate a rank γ precoder based on the CSI report; precode a downlink signal to be transmitted to the wireless communication device based on the rank γ precoder to provide a precoded downlink signal; and transmit the precoded downlink signal to the wireless communication device.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a two-dimensional (2D) active antenna system (AAS).

FIG. 2 illustrates one example of a cellular communications system according to some embodiments of the present disclosure.

FIG. 3 is Table 5.2.2.2.3-5 (Codebook for 1-layer and 2-layer CSI reporting) in 3GPP TS 38.214, version 17.1.0, 2022/4/8.

FIG. 4 is Table 5.2.2.1-2 in 3GPP TS 38.214, version 17.1.0, 2022/4/8.

FIG. 5 is a first flow chart of steps performed by a Radio Network Node (RAN) node in accordance with some embodiments proposed in the present disclosure.

FIG. 6 is a second flow chart of steps performed by the RAN node in accordance with some embodiments proposed in the present disclosure.

FIGS. 7 and 8 illustrate example embodiments in which the cellular communication system of FIG. 2 is a Fifth Generation (5G) System (5GS).

FIG. 9 is a schematic block diagram of a radio access node according to some embodiments of the present disclosure.

FIG. 10 is a schematic block diagram that illustrates a virtualized embodiment of the radio access node of FIG. 9 according to some embodiments of the present disclosure.

FIG. 11 is a schematic block diagram of the radio access node of FIG. 9 according to some other embodiments of the present disclosure.

FIG. 12 is a schematic block diagram of a User Equipment device (UE) according to some embodiments of the present disclosure.

FIG. 13 is a schematic block diagram of the UE of FIG. 12 according to some other embodiments of the present disclosure.

FIG. 14 illustrates a telecommunication network connected via an intermediate network to a host computer in accordance with some embodiments of the present disclosure.

FIG. 15 is a generalized block diagram of a host computer communicating via a base station with a UE over a partially wireless connection in accordance with some embodiments of the present disclosure.

FIG. 16 is a flowchart illustrating a method implemented in a communication system in accordance with one embodiment of the present disclosure.

FIG. 17 is a flowchart illustrating a method implemented in a communication system in accordance with one embodiment of the present disclosure.

FIG. 18 is a flowchart illustrating a method implemented in a communication system in accordance with one embodiment of the present disclosure.

FIG. 19 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCL For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

In some embodiments, a set Transmission Points (TPs) is a set of geographically co-located transmit antennas (e.g., an antenna array (with one or more antenna elements)) for one cell, part of one cell or one Positioning Reference Signal (PRS)-only TP. TPs can include base station (eNB) antennas, Remote Radio Heads (RRHs), a remote antenna of a base station, an antenna of a PRS-only TP, etc. One cell can be formed by one or multiple TPs. For a homogeneous deployment, each TP may correspond to one cell.

In some embodiments, a set of TRPs is a set of geographically co-located antennas (e.g., an antenna array (with one or more antenna elements)) supporting TP and/or Reception Point (RP) functionality.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

3GPP release 15 type II codebook supports only up to two layer transmissions. To perform four layer transmission in Frequency Division Duplex (FDD) systems for UE equipped with four receive antennas, one needs to configure another type I codebook based CSI report for the same UE. This is not always possible as not all commercial UEs support two CSI report configurations. For UEs which support two CSI reports, the second CSI report will result in additional overhead.

The present disclosure proposes several methods which can be used jointly or separately to enable high rank transmissions for NR downlink PDSCH transmissions based on 3GPP release 15 type II CSI report. These methods include, for example, two methods to construct rank 3 and rank 4 precoders based on a rank 2 precoder of a type II CSI report, a method to estimate downlink PDSCH post equalization Signal-to-Noise Ratio (SNR) while eliminating error caused by Channel Quality Indicator (CQI) saturation, and a method to select downlink transmission rank.

With the methods presented in the present disclosure, the downlink rank 3 and rank 4 single user (SU) transmissions can be enabled in NR FDD systems configured with a single release 15 type II CSI report without need to configure another type I CSI report.

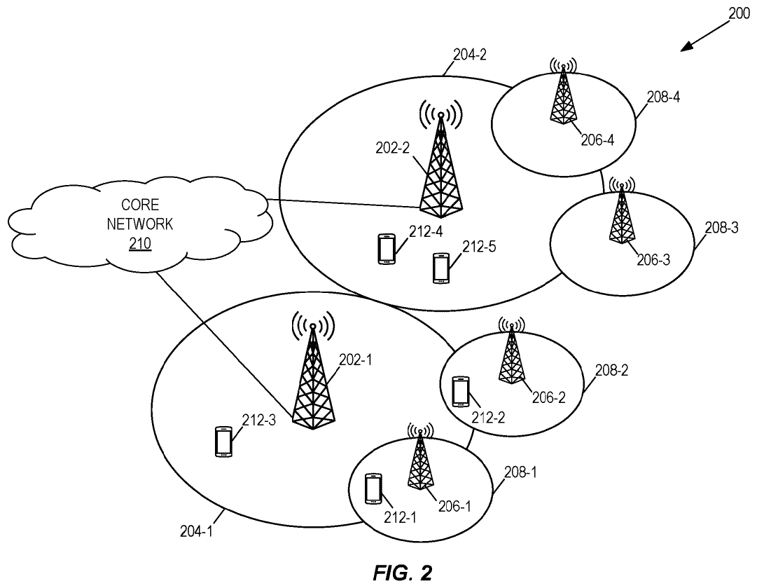

FIG. 2 illustrates one example of a cellular communications system 200 in which embodiments of the present disclosure may be implemented. In the embodiments described herein, the cellular communications system 200 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 202-1 and 202-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or RRHs, or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5G System (5GS) is referred to as the 5GC. The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

### A. NR Release 15 Type II Codebook

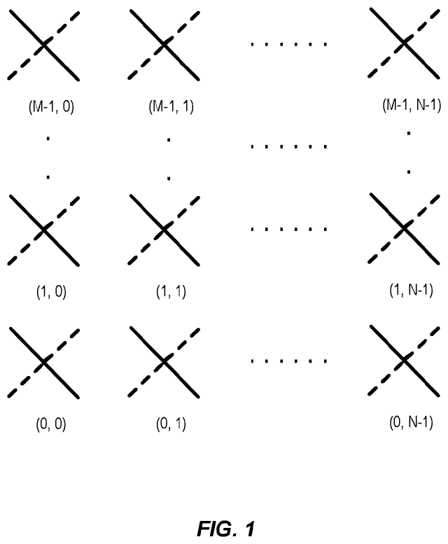

FIG. 1 illustrates a two-dimensional (2D) active antenna system (AAS) that is one of key technologies adopted by 4G LTE and 5G NR to enhance the wireless network performance and capacity by using Full Dimensional Multiple Input Multiple Output (FD-MIMO). In the 2D AAS, antennas placed in the elevation domain provide additional degrees of freedom, which are effectively generated by elevation spread of the channels and the elevation angle distribution of users. A typical 2D directional antenna array is composed of M rows, N columns and two polarizations (cross-polarization) as shown in FIG. 1.

3GPP defines two types of codebook for 5G NR, i.e., type I and type II. Both Type I and Type II codebook are constructed from 2D Discrete Fourier Transform (DFT) based grid of beams and enable the CSI feedback of beam selection as well as Phase Shift Keying (PSK) based co-phase combining between two polarizations. Even though the main motivation to introduce type II codebook is to support downlink MU-MIMO, type II codebook is still defined for a set of hypothetical downlink SU-MIMO schemes. Hence, type II codebook can be used for downlink SU-MIMO transmissions, similar to type I codebook.

Compared to type I codebook, type II CSI report contains more details about channel information such as the wideband and sub-band amplitude information of the selected beams. And type II CSI report selects up to 4 beams for each polarization and combine them linearly, whereas type I CSI report selects only one or two specific beam(s). Thus, type II CSI report can apply more sophisticated precoding and has potential to outperforms type I CSI report.

### B. Precoding Matrix Indication Selection of Type II CSI Report

Let W_{N} be the DFT matrix of size N,

$${W}_{N} = {[ \frac{{ω}^{mn}}{\sqrt{N}} ]}_{m , m = 0 , … , N - 1} , ω = {e}^{- i 2 π / N} \qquad ( 1 )$$

A rotated DFT matrix of size N with phase rotation o/O is defined as:

$${W}_{N} ( o ) = {[ \frac{{ω}^{m ( n + \frac{o}{O} )}}{\sqrt{N}} ]}_{m , n = 0 , … , N - 1 , o = 0 , … , O - 1} , \qquad ( 2 )$$

where O is oversampling rate.

A 2D rotated DFT matrix of size N₁ and oversampling rate O₁ in dimension 1 and size N₂ and oversampling rate O₂ in dimension 2 is defined as:

$${W}_{{N}_{1} , {N}_{2}} ( {o}_{1} , {o}_{2} ) = {W}_{{N}_{2}} ( {o}_{2} ) ⊗ {W}_{{N}_{1}} ( {o}_{1} ) \qquad ( 3 )$$

Note that W_{N1,N2} is an ortho-normal matrix. Any two columns of W_{N1,N2} are orthogonal, and each column of W_{N1,N2} is the weights of a 2D beam for one polarization. For all possible o₁ and o₂, L strongest beams with beam indexes n₁ [n₁⁽⁰⁾, . . . , n₁^{(L-1)}] and n₂=[n₂⁽⁰⁾, . . . , n₂^{(L-1)}], in dimension 1 and dimension 2 respectively, are selected. And q₁ and q₂ are denoted for the values o₁ and o₂, respectively, for which those L beams reach their highest power.

The indexes for beam precoder vₘ_{₁}_{⁽ⁱ⁾}_{,m}_{₂}_{⁽ⁱ⁾} are given by

$${m}_{1}^{( i )} = {O}_{1} {n}_{1}^{( i )} + {q}_{1} \qquad ( 4 )$$

$${m}_{2}^{( i )} = {O}_{2} {n}_{2}^{( i )} + {q}_{2}$$

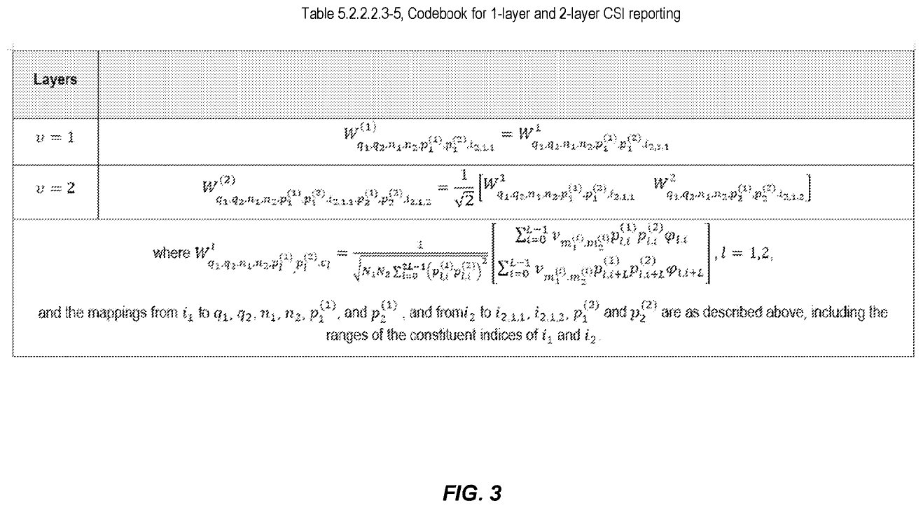

A wideband precoder for one polarization can be defined as

$$w = [ {v}_{{m}_{1}^{( 0 )} , {m}_{2}^{( 0 )}} , … , {v}_{{m}_{1}^{( L - 1 )}} , {m}_{2}^{( L - 1 )} ] \qquad ( 5 )$$

where v_{l,m} is defined in 3GPP TS 38.214, version 17.1.0, 2022/4/8, Table 5.2.2.2.3-5 (reproduced in FIG. 3).

The precoder w contains L strongest paths or beam directions between the RAN node 202 and the wireless communication device (212). As beam directions are the same for two polarizations, w can be extended to two polarizations:

$$W = [ \begin{matrix}w & 0 \\ 0 & w\end{matrix} ] \qquad ( 6 )$$

W is a N_{TX}×2L matrix which represents the directions of 2L beams in the precoder.

Let H be the downlink channel estimates. Each element of H, H_{sb}, is a matrix of dimension N_{RX}×P_{CSI-RS} for each downlink CSI report sub-band, where P_{CSI-RS}=2N₁N₂ is the number of CSI-RS ports and N_{RX} is the number of receive antennas of the wireless communication device 212.

Beam space transformed channel estimates of sub-band (sb) are defined as a N_{RX}×2L matrix:

$${H}_{sb}^{b} = {H}_{sb} W , \qquad ( 7 )$$

A singular value decomposition (SVD) will then be performed for beam-space transmit covariance C_{sb}=H_{sb}^{b} H_{sb}^{b} for each sub-band:

$$[ {U}_{sb} , {s}_{sb} , {V}_{sb}^{H} ] = SVD [ {C}_{sb} ] \qquad ( 8 )$$

For rank γ CSI report, γ strongest eigenvectors in V_{sb}^{H} are used to estimate and quantize wideband amplitude p_{l,i}⁽¹⁾ sub-band amplitude p_{l,i}⁽²⁾ and phase coefficients φ_{l,i} of beam i within 2L beams.

The precoder for each beam i can be then expressed as the product of direction component and amplitude as well as phase components:

$${w}_{i} = {v}_{{m}_{1}^{( i )} , {m}_{{2}_{1}}^{( i )}} {p}_{l , i}^{( 1 )} {p}_{l , i}^{( 2 )} {φ}_{l , i} \qquad ( 9 )$$

The sub-band precoders of type II codebook can be then expressed as the sum of all beam precoders for each polarization as shown in 3GPP TS 38.214, version 17.1.0, 2022/4/8, Table 5.2.2.2.3-5 (reproduced in FIG. 3).

### C. High Rank Precoder Construction

3GPP release 15 type II codebook supports up to 2 layer transmission, hence rank indication (RI) in type II CSI report will be either 1 or 2. If the wireless communication device 212 reports rank 1, then rank 1 is likely optimal for current channel conditions. When the wireless communication device 212 reports rank 2, the optimal rank with current channel conditions could be rank 3 and rank 4 which the wireless communication device 212 cannot report as codebook is limited to maximum rank 2 by 3GPP.

C.1 Construct High Rank Precoder based on Reported Type II Rank 2 Precoder

The rank 2 sub-band precoder in Table 5.2.2.2.3-5 (reproduced in FIG. 3) is denoted as

$${W}^{( 2 )} = \frac{1}{\sqrt{2}} [ {W}^{1} {W}^{2} ] = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ] \qquad ( 10 )$$

where Wₚ_{ₖ}^{l} is a precoder for layer l and polarization k.

Note that layer 1 precoder W¹ and layer 2 precoder W² are two dominant eigen vectors of channel matrix, hence they are orthogonal. Note also that Wₚ_{₁}ⁱ and Wₚ_{₂}ⁱ are also quasi-orthogonal as they are the same base beams mapped to two orthogonal polarizations. A quasi-orthogonal sub-band precoder for rank 4 can then be constructed as:

$${W}^{( 4 )} = \frac{1}{2} [ \begin{matrix}{W}_{{p}_{1}}^{1} & {W}_{{p}_{1}}^{1} & {W}_{{p}_{1}}^{2} & {W}_{{p}_{1}}^{2} \\ {W}_{{p}_{2}}^{1} & - {W}_{{p}_{2}}^{1} & {W}_{{p}_{2}}^{2} & - {W}_{{p}_{2}}^{2}\end{matrix} ] \qquad ( 11 )$$

The rank 3 sub-band precoder can be constructed by taking the first 3 columns of W⁽⁴⁾:

$${W}^{( 3 )} = \frac{1}{\sqrt{3}} [ \begin{matrix}{W}_{{p}_{1}}^{1} & {W}_{{p}_{1}}^{1} & {W}_{{p}_{1}}^{2} \\ {W}_{{p}_{2}}^{1} & - {W}_{{p}_{2}}^{1} & {W}_{{p}_{2}}^{2}\end{matrix} ] \qquad ( 12 )$$

Note that the precoders are scaled by

$$\frac{1}{\sqrt{γ}}$$

for rank γ precoders so that the precoders for all possible ranks have the same total transmit power. Note also that the order of columns in matrices W⁽³⁾ and W⁽⁴⁾ could be different from that illustrated in Equation (11) and Equation (12). In other words, Equation (11) and Equation (12) have column-permuted versions, which are matrices in which any two or more columns of Equation (11) and Equation (12) have been interchanged. The column-permuted versions of Equation (11) and Equation (12) are the same as Equation (11) and Equation (12) but where two or more of the columns of Equation (11) and Equation (12) have been re-arranged.

### C.2 Construct High Rank Precoder Based on Base Beams

The number of base beams L∈{2,3,4} as specified by 3GPP TS 38.214, version 17.1.0, 2022/4/8. Hence type 2 CSI report shown in Table 5.2.2.2.3-5 (reproduced in FIG. 3) contains at least two base beams, i.e., vₘ_{₁}_{⁽⁰⁾}_{,m}_{₂}_{⁽⁰⁾} and vₘ_{₁}_{⁽¹⁾}_{,m}_{₂}_{⁽¹⁾}. Note that these two base beams are orthogonal as explained in the above paragraphs (“B. Precoding Matrix Indication Selection of Type II CSI report”). The orthogonal sub-band precoders for rank 3 and rank 4 can then be constructed as follows:

$${W}^{( 3 )} = \frac{1}{\sqrt{3}} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}}\end{matrix} ] \qquad ( 13 )$$

$${W}^{( 4 )} = \frac{1}{2} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}} & - {v}_{{m}_{1}^{( 1 )} , {m}_{2}^{( 1 )}} {φ}_{l , L + 1}\end{matrix} ] \qquad ( 14 )$$

where φ_{l,i} and φ_{l,i+L}, i=0, 1, are sub-band phase coefficients defined by 3GPP TS 38.214, version 17.1.0, 2022/4/8 and shown in Table 5.2.2.2.3-5 (reproduced in FIG. 3).

One simplification is to set φ_{l,i} and φ_{l,i+L} to 1. As vₘ_{₁}_{⁽ⁱ⁾}_{,m}_{₂}_{⁽ⁱ⁾}, i=0, 1, are wideband, we have wideband rank 3 and rank 4 precoders defined as follows:

$${W}^{( 3 )} = \frac{1}{\sqrt{3}} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}}\end{matrix} ] \qquad ( 15 )$$

$${W}^{( 4 )} = \frac{1}{2} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}} & - {v}_{{m}_{1}^{( 1 )} , {m}_{2}^{( 1 )}}\end{matrix} ] \qquad ( 16 )$$

Note that the order of columns in matrices W⁽³⁾ and W⁽⁴⁾ could be different from that illustrated in Eq. (13) to Eq. (16).

D. Signal to Interference plus Noise Ratio (SINR) Estimation and Rank Selection

This section presents a method to select optimal rank and a method to estimate PDSCH post equalization signal-to-noise ratio (SNR), which is needed for modulation and coding scheme (MCS) selection in subsequent transmissions, if rank 2 reported by the wireless communication device 212 is overridden by the RAN node 202.

A CSI report in a NR wireless system usually includes CQI, precoding matrix indication (PMI) and RI as well as some other indications. CQI is conditioned on RI and PMI contained in the same CSI report, and can be considered as quantized PDSCH post equalization SINR to achieve as closely as possible the desired coding rate indicated by CQI index for reported PMI and RI, according to 3GPP TS 38.214, version 17.1.0, 2022/4/8.

The mapping between PDSCH post equalization SNR and CQI can be represented by a monotonically increasing function ƒ(⋅). Let CQI_{sb}⁽²⁾ be the CQI in the rank 2 CSI report for a CQI report sub-band sb, corresponding SNR can be expressed as

$${SMNR}_{sb}^{( 2 )} = f ( {CQI}_{sb}^{( 2 )} ) \qquad ( 17 )$$

Considering the power split for additional layers, sub-band SNR for rank γ, γ∈{3, 4}, can be approximated as:

$${SNR}_{sb}^{( γ )} = 10 {log}_{10} ( \frac{2}{γ} ) + {SNR}_{sb}^{( 2 )} \qquad ( 18 )$$

The term 10 log₁₀

$$\frac{2}{γ}$$

in Eq. (18) is the power backoff due to the rank override. The
maximum power backoff is 3 dB if rank 4 is selected.

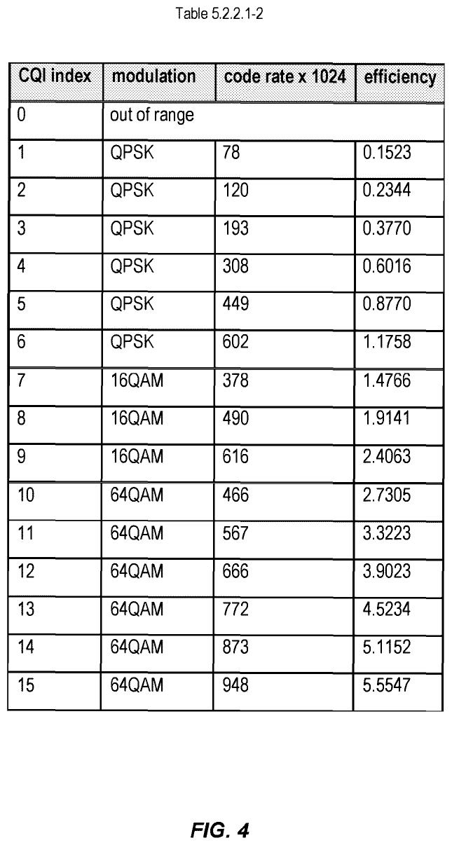

One problem with Eq. (18) is that CQI could be saturated. CQI is specified as an integer from 0 to 15. The highest CQI index 15 represents SNR needed to achieved highest coding rate supported by the standard for given PMI and RI. For example, table 5.2.2.1-2 (reproduced in FIG. 4) of 3GPP TS 38.214, version 17.1.0, 2022/4/8, the SNR is roughly 20 dB for NR. When CQI reported is 15, the actual measured SNR by the wireless communication device 212 could be higher than what CQI 15 represents. In that case, if the RAN node 202 overrides rank reported by the wireless communication device 212 and selects rank 3 or 4 instead, the scaled SNR could be lower than actual SNR perceived by the wireless communication device 212 assuming rank 3 or 4 was selected by the wireless communication device 212.

One way to solve this problem proposed in the present disclosure is to use a parameter ‘powerControlOffset’ defined by 3GPP. The generation of CSI report on the wireless communication device 212 is based on the measurement of NZP CSI-RS resource. When the wireless communication device 212 derives CSI feedback, 3GPP specifies that a powerControlOffset, which is the assumed ratio of PDSCH Energy Per Resource Element (EPRE) to NZP CSI-RS EPRE and takes values in the range of [−8, 15] in unit of dB, can be configurated as disclosed in 3GPP TS 38.214, version 17.1.0, 2022/4/8 and 3GPP TS 38.331, version 16.7.0, 2021/12/23. When a powerControlOffset is configured, the SINR values represented by CQI indexes will be shifted by that amount. Let [symbol] _{sb}⁽²⁾ be the non-shifted SNR for rank 2 CSI report, reported CQI SNR is

$${SNR}_{s b}^{( 2 )} = {sb}_{( 2 )}^{} + powerControlOffset$$

The non-shifted CQI SINR can be recovered on the RAN node 202 by

$${s b}_{( 2 )}^{} = S N {R}_{s b}^{( 2 )} - powerControlOffset$$

When a negative powerControlOffset value x is configured, the non-shifted CQI SINR received on the RAN node 202 will be |x| lower, which means we have additional |x| dB linear range at high SINR end to avoid CQI saturation to happen. One appropriate value for powerControlOffset could be, for example, −3, as the maximum power off is 3 dB.

The SNR in the wireless communication device 212's CQI reports could have estimation error. In practical wireless communication systems, SNR estimation error will be compensated by an outer-loop link adaptation which is driven by downlink ACK/NACK, feedbacked by the wireless communication device 212 after transport block detection. Let OLA^{(γ)} be the outer-loop adjustment for rank γ and assume powerControlOffset is configured with a negative value. The adjusted sub-band SNR [symbol] _{sb}^{(γ)} is given by

$${s b}_{( γ )}^{} = 10 {log}_{10} ( \frac{2}{γ} ) + S N {R}_{s b}^{( 2 )} - powerControlOffset + {OLA}^{( γ )}$$

The wideband SNR is the average of sub-band SNR:

$${w b}_{( γ )}^{} = \frac{1}{{N}_{s b}} {\sum }_{s b = 0}^{{N}_{s b} - 1} S {s b}_{( γ )}^{}$$

wherein N_{sb} is a number of sub-bands.

The optimal rank can be selected based on wideband SNR, i.e.,

$${γ}^{*} = {arg max}_{2 \leq γ \leq 4} ( {w b}_{( γ )}^{} )$$

The MCS for subsequent transmissions can then be determined based on selected rank and estimated SNR.

### E. Additional Description

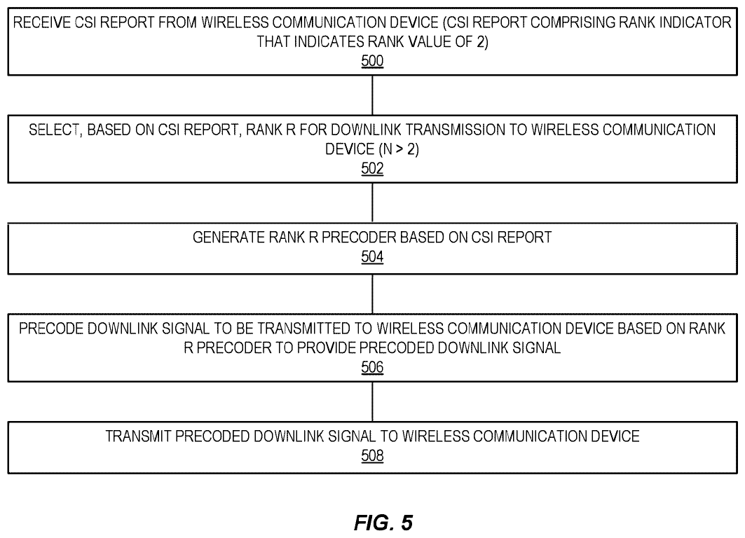

FIG. 5 is a first flow chart of steps performed by the RAN node 202 in accordance with some embodiments proposed in the present disclosure. Specifically, the first flow chart in FIG. 5 shows a method performed by the RAN node 202 comprising the following steps.

In step 500, the RAN node 202 receives, a CSI report from a wireless communication device 212. The CSI report may comprise a rank indicator that indicates a rank value of 2. An example of the CSI report is the 3GPP Type II report.

In step 502, the RAN node 202 selects, based on the CSI report, a rank γ (>2) for downlink transmission to the wireless communication device 212.

In step 504, the RAN node 202 generates a rank γ precoder based on the CSI report. In one embodiment, the RAN node 202 generating the rank γ precoder based on a rank 2 sub-band precoder indicated by the CSI report.

As discussed above, when the rank 2 sub-band precoder indicated by the CSI report is defined as:

$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$

where Wₚ_{ₖ}^{l} is a precoder for layer l and polarization k, and the rank γ precoder is generated based on Wₚ_{₁}¹, Wₚ_{₂}¹, Wₚ_{₁}², and Wₚ_{₂}² such that each column of a corresponding matrix is orthogonal or quasi-orthogonal to each other column of the corresponding matrix.

Also, as discussed above, when the rank γ is rank 3, the rank 2 sub-band precoder indicated by the CSI report is defined as:

$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$

where Wₚ_{ₖ}^{l} is a precoder for layer l and polarization k, and a rank 3 sub-band precoder is generated as or a column-permutated version of:

$${W}^{( 3 )} = \frac{1}{\sqrt{3}} [ \begin{matrix}{W}_{{p}_{1}}^{1} & {W}_{{p}_{1}}^{1} & {W}_{{p}_{1}}^{2} \\ {W}_{{p}_{2}}^{1} & - {W}_{{p}_{2}}^{1} & {W}_{{p}_{2}}^{2}\end{matrix} ]$$

Further, as discussed above, when the rank γ is rank 4, the rank 2 sub-band precoder indicated by the CSI report is defined as:

$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$

where Wₚ_{ₖ}^{l} is a precoder for layer l and polarization k, and a rank 4 sub-band precoder is generated as or a column-permutated version of:

$${W}^{( 4 )} = \frac{1}{2} [ \begin{matrix}{W}_{{p}_{1}}^{1} & {W}_{{p}_{1}}^{1} & {W}_{{p}_{1}}^{2} & {W}_{{p}_{1}}^{2} \\ {W}_{{p}_{2}}^{1} & - {W}_{{p}_{2}}^{1} & {W}_{{p}_{2}}^{2} & - {W}_{{p}_{2}}^{2}\end{matrix} ]$$

In one embodiment, the RAN node 202 generates rank γ sub-band precoder based on at least two of two or more base beams indicated by the CSI report for a rank 2 sub-band precoder. When the rank γ is rank 3, and a rank 3 sub-band precoder is generated as or a column-permutated version of:

$${W}^{( 3 )} = \frac{1}{\sqrt{3}} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}}\end{matrix} ]$$

where vₘ_{₁}_{⁽⁰⁾}_{,m}_{₂}_{⁽⁰⁾} and vₘ_{₁}_{⁽¹⁾}_{,m}_{₂}_{⁽¹⁾} are two of the two or more base beams indicated by the CSI report for the rank 2 sub-band precoder, and φ_{l,i} and φ_{l,i+L}, i=0, 1, are sub-band phase coefficients. Further, as discussed above, the rank 3 wideband precoder, W⁽³⁾, is simplified as

$${W}^{( 3 )} = \frac{1}{\sqrt{3}} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}}\end{matrix} ]$$

wherein φ_{l,i} and φ_{l,i+L} are set to 1 and vₘ_{₁}_{⁽ⁱ⁾}_{,m}_{₂}_{⁽ⁱ⁾}, i=0, 1.

When the rank γ is rank 4, and a rank 4 sub-band precoder is generated as or a column-permutated version of:

$${W}^{( 4 )} = \frac{1}{2} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}} & - {v}_{{m}_{1}^{( 1 )} , {m}_{2}^{( 1 )} {φ}_{l , L + 1}}\end{matrix} ]$$

where vₘ_{₁}_{⁽⁰⁾}_{,m}_{₂}_{⁽⁰⁾} and vₘ_{₁}_{⁽¹⁾}_{,m}_{₂}_{⁽¹⁾} are two of the two or more base beams indicated by the CSI report for the rank 2 sub-band precoder, and φ_{l,i} and φ_{l,i+L}, i=0, 1, are sub-band phase coefficients.

Further, as discussed above, the rank 4 wideband precoder, W⁽⁴⁾, is simplified as

$${W}^{( 4 )} = \frac{1}{2} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}} & - {v}_{{m}_{1}^{( 1 )} , {m}_{2}^{( 1 )}}\end{matrix} ]$$

wherein φ_{l,i} and φ_{l,i+L} are set to 1 and vₘ_{₁}_{⁽ⁱ⁾}_{,m}_{₂}_{⁽ⁱ⁾}, i=0, 1.

In one embodiment, the CSI report comprises one or more CQI values for rank 2. In one embodiment, the step of selecting (502) the rank γ for downlink transmission to the wireless communication device (212) comprises selecting the rank γ based on the one or more CQI values for rank 2 comprised in the CSI report. In one embodiment, selecting (502) the rank γ for downlink transmission to the wireless communication device (212) comprises selecting the rank γ based on the one or more CQI values for rank 2 comprised in the CSI report and a power control offset value configured for the wireless communication device (212).

In step 506, the RAN node 202 performs precoding of a downlink signal to be transmitted to the wireless communication device 212 based on the rank γ precoder to provide a precoded downlink signal.

In step 508, the RAN node 202 transmits the precoded downlink signal to the wireless communication device 212.

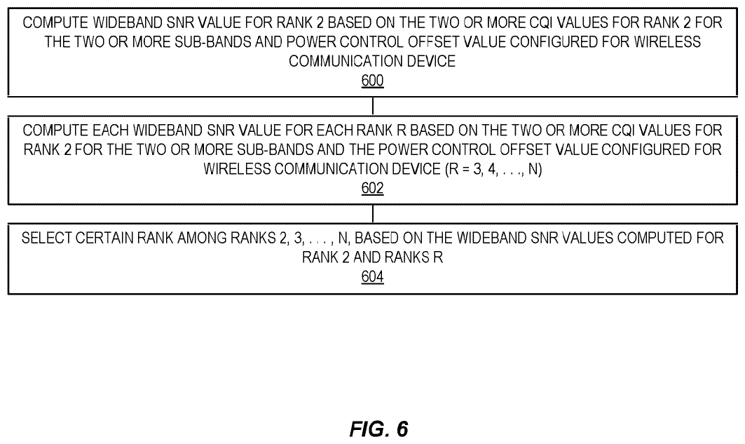

FIG. 6 is a second flow chart of steps performed by the RAN in accordance with some embodiments proposed in the present disclosure. Specifically, when the step 502 (in FIG. 5) of selecting the rank γ for downlink transmission to the wireless communication device 212 comprises (i) selecting the rank γ based on the one or more CQI values for rank 2 comprised in the CSI report and a power control offset value configured for the wireless communication device 212 and (ii) the one or more CQI values comprise two or more CQI values for rank 2 for two or more sub-bands, the step 502 (in FIG. 5) of selecting the rank γ for downlink transmission to the wireless communication device 212 comprises the following steps.

In step 600, the RAN node 202 computes a wideband SNR value for rank 2 based on the two or more CQI values for rank 2 for the two or more sub-bands and the power control offset value configured for the wireless communication device 212.

In step 602, the RAN node 202 computes a wideband SNR value for each rank γ from among two or more additional ranks based on the two or more CQI values for rank 2 for the two or more sub-bands and the power control offset value configured for the wireless communication device 212, when γ is greater than 2 and is equal to or less than N that is a maximum rank.

In step 604, the RAN node 202 selects a certain rank among ranks (2, 3, . . . , and N) based on the wideband SNR values computed for rank 2 and ranks γ among the two or more additional ranks.

As discussed above, in one embodiment, the step of computing (600) the wideband SNR value for rank 2 based on the two or more CQI values for rank 2 for the two or more sub-bands and the power control offset value configured for the wireless communication device (212) comprises computing non-shifted SNR values for rank 2 ( [symbol] _{sb}⁽²⁾) by using:

$${s b}_{( 2 )}^{} = S N {R}_{s b}^{( 2 )} - powerControlOffset$$

wherein SNR_{sb}⁽²⁾ is SNR values for rank 2 CSI report; powerControlOffset is a power control offset that is an assumed ratio of PDSCH EPRE to NZP CSI-RS EPRE.

As discussed above, in one embodiment, the step of computing (602) the wideband SNR value for each rank γ based on the two or more CQI values for rank 2 for the two or more sub-bands and the power control offset value configured for the wireless communication device (212) comprises computing non-shifted SNR values for rank γ ( [symbol] _{sb}^{(γ)}) by using:

$${s b}_{( γ )}^{} = 10 {log}_{10} ( \frac{2}{γ} ) + S N {R}_{s b}^{( 2 )} - powerControlOffset + {OLA}^{( γ )}$$

wherein SNR_{sb}⁽²⁾ is SNR values for rank 2 CSI report; powerControlOffset is a power control offset that is an assumed ratio of PDSCH EPRE to NZP CSI-RS EPRE; OLA^{(γ)} is an outer-loop adjustment for the rank γ.

As discussed above, in one embodiment, the step of computing (602) the wideband SNR value for each rank γ based on the two or more CQI values for rank 2 for the two or more sub-bands and the power control offset value configured for the wireless communication device (212) further comprises computing the wideband SNR value for each rank γ by using:

$${w b}_{( γ )}^{} = \frac{1}{{N}_{s b}} {\sum }_{s b = 0}^{{N}_{s b} - 1} {s b}_{( γ )}^{}$$

wherein [symbol] _{sb}^{(γ)} is non-shifted SNR values for rank γ and N_{sb} is a number of sub-bands.

As discussed above, in one embodiment, the step of selecting (604) the certain rank among ranks 2, 3, . . . , and N, based on the wideband SNR values computed for rank 2 and ranks γ comprises selecting the certain rank by using:

$${γ}^{*} = {arg max}_{2 \leq γ \leq N} ( {w b}_{( γ )}^{} )$$

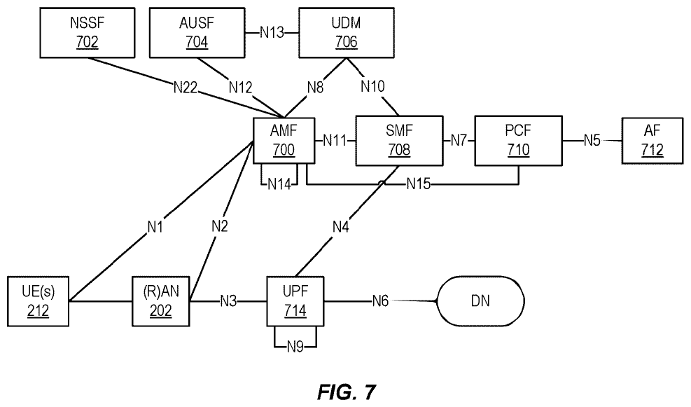

FIG. 7 illustrates a wireless communication system represented as a 5G network architecture composed of core Network Functions (NFs), where interaction between any two NFs is represented by a point-to-point reference point/interface. FIG. 7 can be viewed as one particular implementation of the system 200 of FIG. 2.

Seen from the access side the 5G network architecture shown in FIG. 7 comprises a plurality of UEs 212 connected to either a RAN 202 or an Access Network (AN) as well as an AMF 700. Typically, the R(AN) 202 comprises base stations, e.g., such as eNBs or gNBs or similar. Seen from the core network side, the 5GC NFs shown in FIG. 7 include a NSSF 702, an AUSF 704, a UDM 706, the AMF 700, a SMF 708, a PCF 710, and an Application Function (AF) 712.

Reference point representations of the 5G network architecture are used to develop detailed call flows in the normative standardization. The N1 reference point is defined to carry signaling between the UE 212 and AMF 700. The reference points for connecting between the AN 202 and AMF 700 and between the AN 202 and UPF 714 are defined as N2 and N3, respectively. There is a reference point, N11, between the AMF 700 and SMF 708, which implies that the SMF 708 is at least partly controlled by the AMF 700. N4 is used by the SMF 708 and UPF 714 so that the UPF 714 can be set using the control signal generated by the SMF 708, and the UPF 714 can report its state to the SMF 708. N9 is the reference point for the connection between different UPFs 714, and N14 is the reference point connecting between different AMFs 700, respectively. N15 and N7 are defined since the PCF 710 applies policy to the AMF 700 and SMF 708, respectively. N12 is required for the AMF 700 to perform authentication of the UE 212. N8 and N10 are defined because the subscription data of the UE 212 is required for the AMF 700 and SMF 708.

The 5GC network aims at separating UP and CP. The UP carries user traffic while the CP carries signaling in the network. In FIG. 7, the UPF 714 is in the UP and all other NFs, i.e., the AMF 700, SMF 708, PCF 710, AF 712, NSSF 702, AUSF 704, and UDM 706, are in the CP. Separating the UP and CP guarantees each plane resource to be scaled independently. It also allows UPFs to be deployed separately from CP functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF 700 and SMF 708 are independent functions in the CP. Separated AMF 700 and SMF 708 allow independent evolution and scaling. Other CP functions like the PCF 710 and AUSF 704 can be separated as shown in FIG. 7. Modularized function design enables the 5GC network to support various services flexibly.

Each NF interacts with another NF directly. It is possible to use intermediate functions to route messages from one NF to another NF. In the CP, a set of interactions between two NFs is defined as service so that its reuse is possible. This service enables support for modularity. The UP supports interactions such as forwarding operations between different UPFs.

FIG. 8 illustrates a 5G network architecture using service-based interfaces between the NFs in the CP, instead of the point-to-point reference points/interfaces used in the 5G network architecture of FIG. 7. However, the NFs described above with reference to FIG. 7 correspond to the NFs shown in FIG. 8. The service(s) etc. that a NF provides to other authorized NFs can be exposed to the authorized NFs through the service-based interface. In FIG. 8 the service based interfaces are indicated by the letter “N” followed by the name of the NF, e.g., Namf for the service based interface of the AMF 700 and Nsmf for the service based interface of the SMF 708, etc. The NEF 800 and the NRF 802 in FIG. 8 are not shown in FIG. 7 discussed above. However, it should be clarified that all NFs depicted in FIG. 7 can interact with the NEF 800 and the NRF 802 of FIG. 8 as necessary, though not explicitly indicated in FIG. 7.

Some properties of the NFs shown in FIGS. 7 and 8 may be described in the following manner. The AMF 700 provides UE-based authentication, authorization, mobility management, etc. A UE 212 even using multiple access technologies is basically connected to a single AMF 700 because the AMF 700 is independent of the access technologies. The SMF 708 is responsible for session management and allocates Internet Protocol (IP) addresses to UEs. It also selects and controls the UPF 714 for data transfer. If a UE 212 has multiple sessions, different SMFs 708 may be allocated to each session to manage them individually and possibly provide different functionalities per session. The AF 712 provides information on the packet flow to the PCF 710 responsible for policy control in order to support QoS. Based on the information, the PCF 710 determines policies about mobility and session management to make the AMF 700 and SMF 708 operate properly. The AUSF 704 supports authentication function for UEs or similar and thus stores data for authentication of UEs or similar while the UDM 706 stores subscription data of the UE 212. The Data Network (DN), not part of the 5GC network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

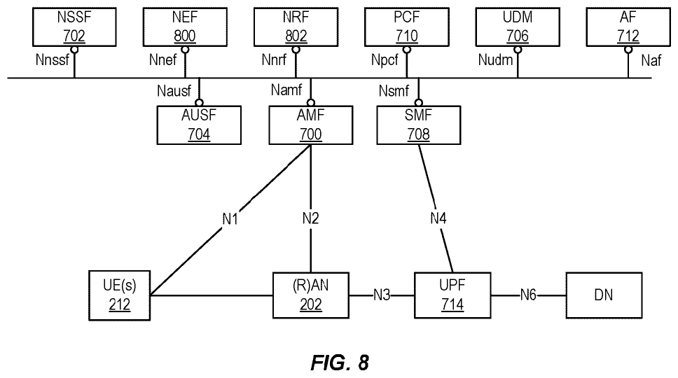

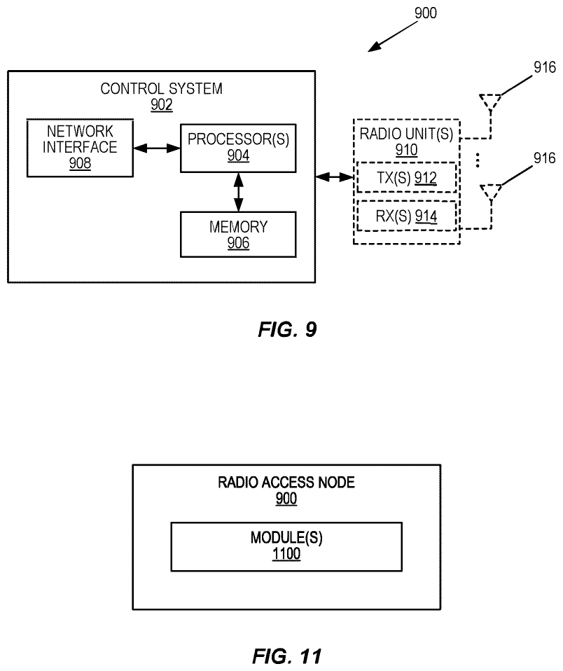

FIG. 9 is a schematic block diagram of a radio access node 900 according to some embodiments of the present disclosure. Optional features are represented by dashed boxes. The radio access node 900 may be, for example, a base station 202 or 206 or a network node that implements all or part of the functionality of the base station 202 or gNB described herein. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

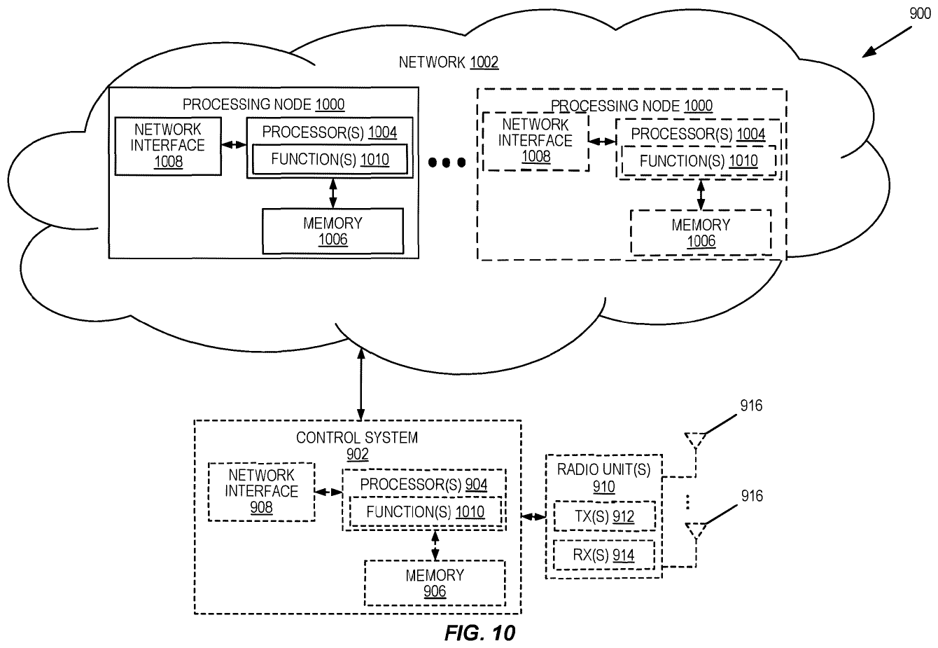

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the one or more processing nodes 1000 and the control system 902 and/or the radio unit(s) 910 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

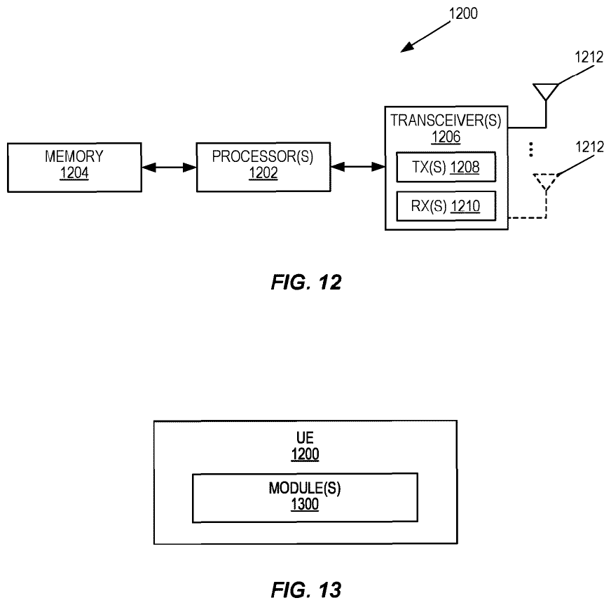

FIG. 12 is a schematic block diagram of a wireless communication device 1200 according to some embodiments of the present disclosure. As illustrated, the wireless communication device 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the wireless communication device 1200 described above may be fully or partially implemented in software that is, e.g., stored in the memory 1204 and executed by the processor(s) 1202. Note that the wireless communication device 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the wireless communication device 1200 and/or allowing output of information from the wireless communication device 1200), a power supply (e.g., a battery and associated power circuitry), etc.

In some embodiments, a computer program including instructions which, when executed by at least one processor, causes the at least one processor to carry out the functionality of the wireless communication device 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the wireless communication device 1200 according to some other embodiments of the present disclosure. The wireless communication device 1200 includes one or more modules 1300, each of which is implemented in software. The module(s) 1300 provide the functionality of the wireless communication device 1200 described herein.

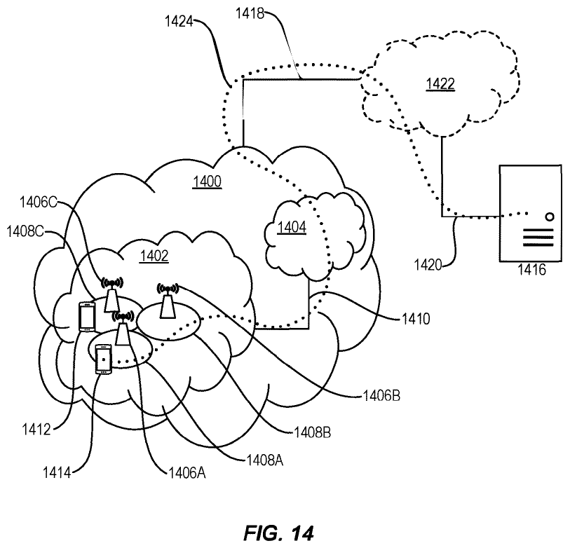

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as Node Bs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

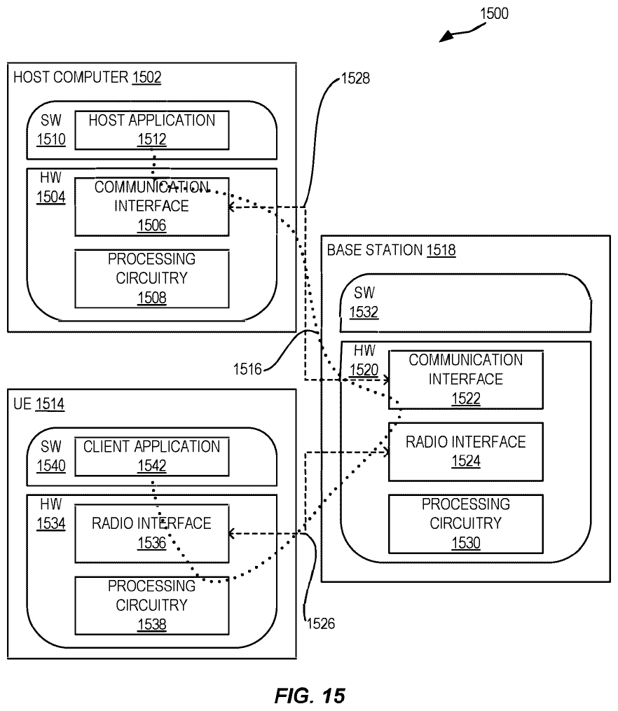

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment. More precisely, the teachings of these embodiments may improve the data rate, latency, power consumption and thereby provide benefits such as reduced user waiting time, relaxed restriction on file size, better responsiveness, extended battery lifetime.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer's 1502 measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

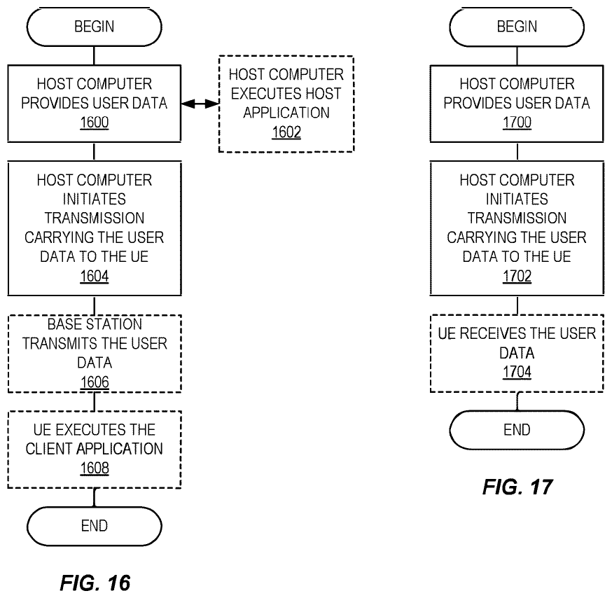

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

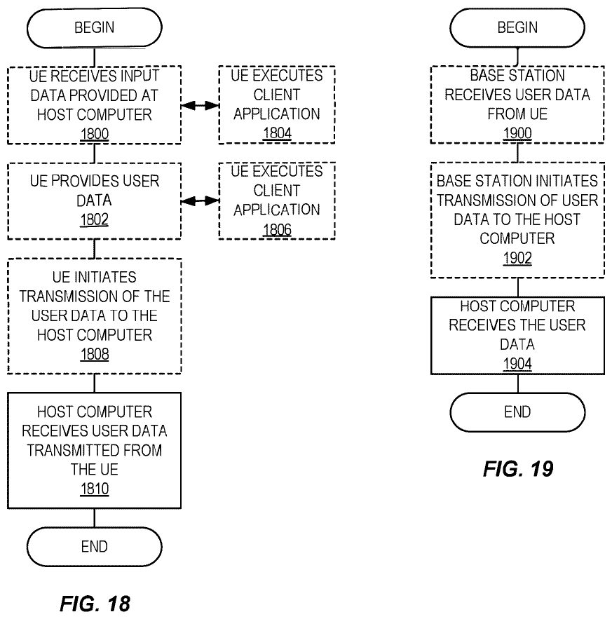

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UE receives input data provided by the host computer. Additionally or alternatively, in step 1802, the UE provides user data. In sub-step 1804 (which may be optional) of step 1800, the UE provides the user data by executing a client application. In sub-step 1806 (which may be optional) of step 1802, the UE executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
2D Two-Dimensional
3GPP Third Generation Partnership Project
5G Fifth Generation
5GC Fifth Generation Core
5GS Fifth Generation System
AAS Active Antenna system
AF Application Function
AMF Access and Mobility Function
AN Access Network
AP Access Point
ASIC Application Specific Integrated Circuit
AUSF Authentication Server Function
CPU Central Processing Unit
CQI Channel Quality Indicator
CSI Channel State Information
CSI-RS Channel State Information Reference Signal
DCI Downlink Control Information
DFT Discrete Fourier Transform
DL Downlink
DN Data Network
DSP Digital Signal Processor
eNB Enhanced or Evolved Node B
EPRE Energy Per Resource Element
EPS Evolved Packet System
E-UTRA Evolved Universal Terrestrial Radio Access
FDD Frequency Division Duplex
FD-MIMO Full Dimensional Multiple Input Multiple Output
FPGA Field Programmable Gate Array
gNB New Radio Base Station
gNB-DU New Radio Base Station Distributed Unit
HSS Home Subscriber Server
IoT Internet of Things
IP Internet Protocol
LTE Long Term Evolution
MAC Medium Access Control
MCS Modulation and Coding Scheme
MIMO Multiple Input Multiple Output
MME Mobility Management Entity
MTC Machine Type Communication
NEF Network Exposure Function
NF Network Function
NR New Radio
NRF Network Function Repository Function
NSSF Network Slice Selection Function
NZP Non-Zero Power
OTT Over-the-Top
PC Personal Computer
PCF Policy Control Function
PDSCH Physical Downlink Shared Channel
P-GW Packet Data Network Gateway
PMI Precoding Matrix Indication
PRS Positioning Reference Signal
PSK Phase Shift Keying
QoS Quality of Service
RAM Random Access Memory
RAN Radio Access Network
RI Rank Indication
ROM Read Only Memory
RP Reception Point
RRH Remote Radio Head
RTT Round Trip Time
SCEF Service Capability Exposure Function
SINR Signal to Interference plus Noise Ratio
SMF Session Management Function
SNR Signal to Noise Ratio
SRS Sounding Reference Signal
SU-MIMO Single-user Multiple Input Multiple Output
SVD Singular Value Decomposition
TCI Transmission Configuration Indicator
TDD Time Division Duplex
TP Transmission Point
TRP Transmission/Reception Point
UDM Unified Data Management
UE User Equipment
UL Uplink
UPF User Plane Function

Those skilled in the art will recognize improvements and modifications to the embodiments of the present disclosure. All such improvements and modifications are considered within the scope of the concepts disclosed herein.

1. A method performed by a Radio Access Network, RAN, node in a RAN of a cellular communications system, the method comprising:
receiving, a Channel State Information, CSI, report from a wireless communication device, the CSI report comprising a rank indicator that indicates a rank value of 2;
selecting, based on the CSI report, a rank γ for downlink transmission to the wireless communication device, wherein γ>2;
generating a rank γ precoder based on the CSI report;
precoding a downlink signal to be transmitted to the wireless communication device based on the rank γ precoder to provide a precoded downlink signal; and
transmitting the precoded downlink signal to the wireless communication device.

2. The method of claim 1 wherein the CSI report is a Third Generation Partnership Project, 3GPP, Type II report.

3. The method of claim 1 wherein generating the rank γ precoder based on the CSI report comprises generating the rank γ precoder based on a rank 2 sub-band precoder indicated by the CSI report.

4. The method of claim 3 wherein the rank 2 sub-band precoder indicated by the CSI report is defined as:
$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$
where Wₚ_{ₖ}¹ is a precoder for layer l and polarization k, and the rank γ precoder is generated based on Wₚ_{₁}¹, Wₚ_{₂}¹, Wₚ_{₁}², and Wₚ_{₂}² such that each column of a corresponding matrix is orthogonal or quasi-orthogonal to each other column of the corresponding matrix.

5. The method of claim 3 wherein the rank γ is rank 3, the rank 2 sub-band precoder indicated by the CSI report is defined as:
$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$
where Wₚ_{ₖ}^{l} is a precoder for layer l and polarization k, and a rank 3 sub-band precoder is generated as or a column-permutated version of:
$${W}^{( 3 )} = \frac{1}{\sqrt{3}} [ \begin{matrix}{W}_{{p}_{1}}^{1} & {W}_{{p}_{1}}^{1} & {W}_{{p}_{1}}^{2} \\ {W}_{{p}_{2}}^{1} & - {W}_{{p}_{2}}^{1} & {W}_{{p}_{2}}^{2}\end{matrix} ] .$$

6. The method of claim 3 wherein the rank γ is rank 4, the rank 2 sub-band precoder indicated by the CSI report is defined as:
$${W}^{( 2 )} = \frac{1}{\sqrt{2}} [ \begin{matrix}{W}_{{p}_{1}}^{1} & {W}_{{p}_{1}}^{2} \\ {W}_{{p}_{2}}^{1} & {W}_{{p}_{2}}^{2}\end{matrix} ]$$
where Wₚ_{ₖ}^{l} is a precoder for layer l and polarization k, and a rank 4 sub-band precoder is generated as or a column-permutated version of:
$${W}^{( 4 )} = \frac{1}{\sqrt{2}} [ \begin{matrix}{W}_{{p}_{1}}^{1} & {W}_{{p}_{1}}^{1} & {W}_{{p}_{1}}^{2} & {W}_{{p}_{1}}^{2} \\ {W}_{{p}_{2}}^{1} & - {W}_{{p}_{2}}^{1} & {W}_{{p}_{2}}^{2} & - {W}_{{p}_{2}}^{2}\end{matrix} ] .$$

7. The method of claim 1 wherein generating the rank γ precoder based on the CSI report comprises generating the rank γ sub-band precoder based on at least two of two or more base beams indicated by the CSI report for a rank 2 sub-band precoder.

8. The method of claim 7 wherein the rank γ is rank 3, and a rank 3 sub-band precoder is generated as or a column-permutated version of:
$${W}^{( 3 )} = \frac{1}{\sqrt{3}} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}}\end{matrix} ]$$
where vₘ_{₁}_{⁽⁰⁾}_{,m}_{₂}_{⁽⁰⁾} and vₘ_{₁}_{⁽¹⁾}_{,m}_{₂}_{⁽¹⁾} are two of the two or more base beams indicated by the CSI report for the rank 2 sub-band precoder, and φ_{l,i} and φ_{l,i+L}, i=0, 1, are sub-band phase coefficients.

9. The method of claim 8 wherein the rank 3 wideband precoder, W⁽³⁾, is simplified as:
$${W}^{( 3 )} = \frac{1}{\sqrt{3}} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2}^{( 1 )}}\end{matrix} ]$$
wherein φ_{l,i} and φ_{l,i+L} are set to 1 and vₘ_{₁}_{⁽ⁱ⁾}_{,m}_{₂}_{⁽ⁱ⁾}, i=0, 1.

10. The method of claim 7 wherein the rank γ is rank 4, and a rank 4 sub-band precoder is generated as or a column-permutated version of:
$${W}^{( 4 )} = \frac{1}{2} [ \begin{matrix}{v}_{{m}_{1}^{( 0 )} , {m}_{2}^{( 0 )} {φ}_{l , 0}} & {v}_{{m}_{1}^{( 0 )} , {m}_{2}^{( 0 )} {φ}_{l , 0}} & {v}_{{m}_{1}^{( 1 )} , {m}_{2}^{( 1 )} {φ}_{l , 1}} & {v}_{{m}_{1}^{( 1 )} , {m}_{2}^{( 1 )} {φ}_{l , 1}} \\ {v}_{{m}_{1}^{( 0 )} , {m}_{2}^{( 0 )} {φ}_{l , L}} & - {v}_{{m}_{1}^{( 0 )} , {m}_{2}^{( 0 )} {φ}_{l , L}} & {v}_{{m}_{1}^{( 1 )} , {m}_{2}^{( 1 )} {φ}_{l , L + 1}} & - {v}_{{m}_{1}^{( 1 )} , {m}_{2}^{( 1 )} {φ}_{l , L + 1}}\end{matrix} ]$$
where vₘ_{₁}_{⁽⁰⁾}_{,m}_{₂}_{⁽⁰⁾} and vₘ_{₁}_{⁽¹⁾}_{,m}_{₂}_{⁽¹⁾} are two of the two or more base beams indicated by the CSI report for the rank 2 sub-band precoder, and φ_{l,i} and φ_{l,i+L}, i=0, 1, are sub-band phase coefficients.

11. The method of claim 10 wherein the rank 4 wideband precoder, W⁽⁴⁾, is simplified as
$${W}^{( 4 )} = \frac{1}{2} [ \begin{matrix}{v}_{{m}_{1}^{( 0 )} , {m}_{2}^{( 0 )}} & {v}_{{m}_{1}^{( 0 )} , {m}_{2}^{( 0 )}} & {v}_{{m}_{1}^{( 1 )} , {m}_{2}^{( 1 )}} & {v}_{{m}_{1}^{( 1 )} , {m}_{2}^{( 1 )}} \\ {v}_{{m}_{1}^{( 0 )} , {m}_{2}^{( 0 )}} & - {v}_{{m}_{1}^{( 0 )} , {m}_{2}^{( 0 )}} & {v}_{{m}_{1}^{( 1 )} , {m}_{2 }^{( 1 )}} & - {v}_{{m}_{1}^{( 1 )} , {m}_{2}^{( 1 )}}\end{matrix} ]$$
wherein φ_{l,i} and φ_{l,i+L} are set to 1 and vₘ_{₁}_{⁽ⁱ⁾}_{,m}_{₂}_{⁽ⁱ⁾}, i=0, 1.

12. The method of claim 1 wherein the CSI report comprises one or more Channel Quality Indictor, CQI, values for rank 2.

13. The method of claim 12 wherein selecting the rank γ for downlink transmission to the wireless communication device comprises selecting the rank γ based on the one or more CQI values for rank 2 comprised in the CSI report.

14. The method of claim 12 wherein selecting the rank γ for downlink transmission to the wireless communication device comprises selecting the rank γ based on the one or more CQI values for rank 2 comprised in the CSI report and a power control offset value configured for the wireless communication device.

15. The method of claim 14 wherein the one or more CQI values comprise two or more CQI values for rank 2 for two or more sub-bands, and selecting the rank γ comprises:
computing a wideband Signal-to-Noise Ratio, SNR, value for rank 2 based on the two or more CQI values for rank 2 for the two or more sub-bands and the power control offset value configured for the wireless communication device;
computing a wideband SNR value for each rank γ from among two or more additional ranks based on the two or more CQI values for rank 2 for the two or more sub-bands and the power control offset value configured for the wireless communication device, wherein γ is greater than 2 and is equal to or less than N that is a maximum rank; and
selecting a certain rank among ranks 2, 3, . . . , and N, based on the wideband SNR values computed for rank 2 and ranks γ among the two or more additional ranks.

16. The method of claim 15 wherein computing the wideband SNR value for rank 2 based on the two or more CQI values for rank 2 for the two or more sub-bands and the power control offset value configured for the wireless communication device comprises computing non-shifted SNR values for rank 2 ( [symbol] _{sb}⁽²⁾) by using:
$${s b}_{( 2 )}^{} = S N {R}_{s b}^{( 2 )} - powerControlOffset$$
wherein SNR_{sb}⁽²⁾ is SNR values for rank 2 CSI report; powerControlOffset is a power control offset that is an assumed ratio of Physical Downlink Shared Channel, PDSCH, Energy Per Resource Element, EPRE, to Non-Zero Power, NZP, Channel State Information Reference Signal, CSI-RS, EPRE.

17. The method of claim 16 wherein computing the wideband SNR value for each rank γ based on the two or more CQI values for rank 2 for the two or more sub-bands and the power control offset value configured for the wireless communication device comprises computing non-shifted SNR values for rank γ ( [symbol] _{sb}^{(γ)}) by using:
$${s b}_{( γ )}^{} = 10 {log}_{10} ( \frac{2}{γ} ) + S N {R}_{s b}^{( 2 )} - powerControlOffset + {OLA}^{( γ )}$$
wherein SNR_{sb}⁽²⁾ is SNR values for rank 2 CSI report; powerControlOffset is a power control offset that is an assumed ratio of Physical Downlink Shared Channel, PDSCH, Energy Per Resource Element, EPRE, to NZP Channel State Information Reference Signal, CSI-RS, EPRE; OLA^{(γ)} is an outer-loop adjustment for the rank γ.

18. The method of claim 17 wherein computing the wideband SNR value for each rank γ based on the two or more CQI values for rank 2 for the two or more sub-bands and the power control offset value configured for the wireless communication device further comprises computing the wideband SNR value for each rank γ by using:
$${w b}_{( γ )}^{} = \frac{1}{{N}_{s b}} {\sum }_{s b = 0}^{{N}_{s b} - 1} {s b}_{( γ )}^{}$$
wherein [symbol] _{sb}^{(γ)}) is non-shifted SNR values for rank γ and N_{sb} is a number of sub-bands.

19. The method of claim 18 wherein selecting the certain rank among ranks 2, 3, . . . , and N, based on the wideband SNR values computed for rank 2 and ranks γ comprises selecting the certain rank by using:
$${γ}^{*} = {arg max}_{2 \leq γ \leq N} ( {w b}_{( γ )}^{} ) .$$

20. A Radio Access Network, RAN, node in a RAN of a cellular communications system adapted to:
receive, a Channel State Information, CSI, report from a wireless communication device, the CSI report comprising a rank indicator that indicates a rank value of 2;
select, based on the CSI report, a rank γ for downlink transmission to the wireless communication device, wherein γ>2;
generate a rank γ precoder based on the CSI report;
precode a downlink signal to be transmitted to the wireless communication device based on the rank γ precoder to provide a precoded downlink signal; and
transmit the precoded downlink signal to the wireless communication device.

21-23. (canceled)
